(19) United States
(12) Patent Application Publication
(10) Pub. No.: US 2003/0036859 A1
(43) Pub. Date: Feb. 20, 2003

(54) Method and apparatus for operating a rain sensor of a motor vehicle

(76) Inventors: Werner Robert Muller, Griesheim (DE); Andreas Baitz, Russelsheim (DE)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/213,937

(22) Filed: Aug. 6, 2002

(30) Foreign Application Priority Data
Aug. 14, 2001 (DE) 10139817.4

(51) Int. Cl. G01F 1/00; G01F 7/00; G06F 19/00

(52) U.S. Cl. 702/45

(57) ABSTRACT

A method and apparatus for operating a rain sensor of a motor vehicle that is connected to an onboard wiring system, the rain sensor being supplied with current in cyclic intervals via a control device connected to the onboard wiring system.

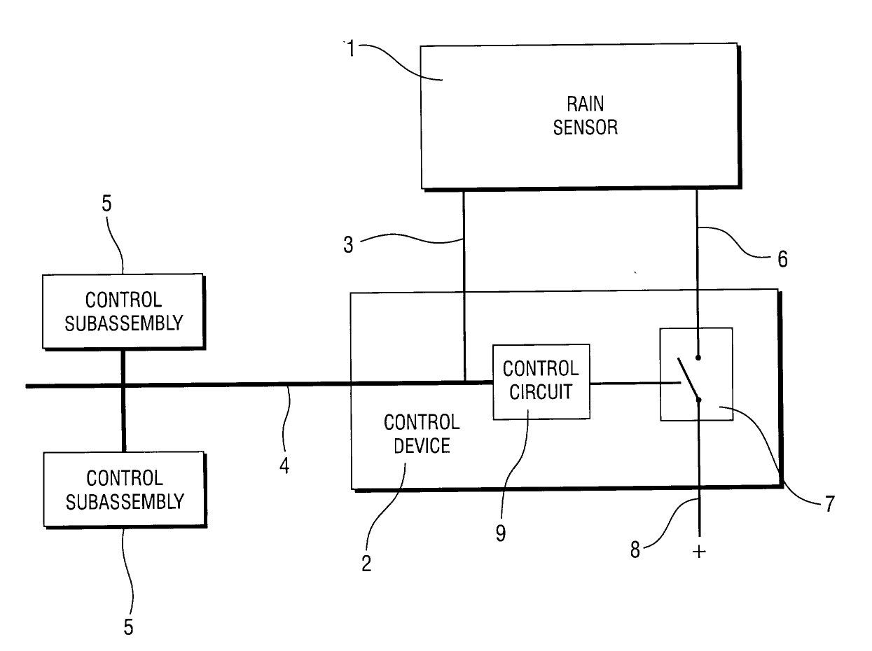

### TECHNICAL FIELD

The invention concerns a process for operating a rain sensor of a motor vehicle which is connected to the onboard wiring system, a device for controlling a rain sensor of a motor vehicle, the onboard wiring system, and a data bus belonging to it especially for execution of the process.

### BACKGROUND OF THE INVENTION

EP 438 633 B1 concerns a process for controlling a windshield wiper in which a rain sensor arranged on the windshield to be wiped emits a signal as a function of the amount of moisture which controls the continuous or intermittent operation of the windshield wiper.

DE 200 21 416 U1 discloses a rain guard for a parked convertible comprising automatic closing of the top in which a rain sensor is connected to the top-closing activator of the vehicle. If rain falls on the parked vehicle, the top is closed under the control of the rain sensor.

### SUMMARY OF THE INVENTION

A rain sensor is usually either permanently powered by current or is capable of functioning via the ignition voltage of the motor vehicle only in its operating state. The disadvantage of both of these variants is the fact that the rain sensor is either only functional during vehicle operation or its current consumption is relatively high, especially in a parked motor vehicle.

The objective of the invention is to formulate a process for operating a rain sensor of the type mentioned initially comprising a device for actuating a rain sensor in which the current consumption of the rain sensor is reduced without limiting its functionality.

The problem is solved, according to the invention, by supplying the rain sensor with current in cyclic intervals by a control device connected to the onboard wiring system.

In this way a reduced average current consumption is achieved, as compared to permanent current supply to the rain sensor, by which the detection of rain can be assured especially in the case of a parked motor vehicle without the risk of totally discharging the vehicle battery.

According to another modification of the invention, the cyclic current supply of the rain sensor is periodically governed in time by a control circuit connected to a control device. The rain sensor of the present invention operates independently of the operating state of the vehicle, making rain detection and the corresponding information processing practical even in the case of a parked vehicle.

Alternatively or additionally, the current supply to the rain sensor is governed by at least one device-controlling subassembly via a data bus connected to the control device. This makes it possible to switch the rain sensor on as a function of other devices of the motor vehicle or to influence the switching behavior by one of these devices. Such other devices include, but are not limited to, a windshield wiper motor, a window-raising motor and a motor for a lifting/sliding roof or their switching devices. By coupling the rain sensor with the device-controlling subassembly for the windshield wiper, it is possible to limit the current supply to the rain sensor during vehicle operation to the activation time of the windshield wiping function. In the case of a connection of the rain sensor to the device control subassembly for the window raising motors, the periodically current-supplied rain sensor can coordinate and implement the closing of the windows or the sliding roof, even in the case of a parked vehicle.

The lowest possible current consumption is achieved by the fact that the time interval in which the rain sensor is supplied with current is small compared to the time during which the rain sensor is not supplied with current.

The problem is solved in construction terms by the device for actuating the rain sensor of a motor vehicle which is coordinated with the onboard wiring system and a data bus, especially for executing the process according to the invention. The rain sensor, with an interposed control device that switches the current supply of the rain sensor on and off, is connected by a coordinated switch to the onboard wiring system.

The rain sensor employed is unchanged compared to conventional rain sensors, and the control device includes the logic system for operating a switch such that the current consumption of the rain sensor is substantially reduced by the variably adjustable on-and-off switching times, as compared to a continuous current supply.

The control device preferably switches the current supply periodically on and off by means of a control circuit. By this measure, the current consumption of the rain sensor can be further reduced, and simultaneously operational readiness at any time can be achieved.

In order to achieve a compact construction, the switches and the control circuit are designed as semiconductor elements and form the control device as an integrated circuit.

The control device is preferably connected to the control system with at least one device-controlling subassembly for actuating the electric motor via a data bus. The data bus with the coordinated device controlling subassemblies assures the exchange of data between the rain sensor and the final devices to be operated.

The features mentioned above and described below can be used not only in the combination reported herein but also in other combinations without extending beyond the scope of the invention.

The invention is explained in more detail below with reference to examples of embodiment illustrated in the corresponding drawing.

### BRIEF DESCRIPTION OF THE DRAWINGS

The single FIGURE shows a circuit diagram of the device according to the invention.

### DESCRIPTION OF THE PREFERRED EMBODIMENT

A rain sensor 1 of a motor vehicle (not shown) is connected to a control device 2 via a serial data line 3. The rain sensor 1 transmits data via the serial data line 3 connected to the data bus 4 to the control device 2 which, in turn, is connected to a data bus 4. The data bus 4 is connected to other device-controlling subassemblies 5 with data-processing functionality. The number of device-controlling subassemblies 5 is flexible; for simplicity, the drawing FIGURE shows two device-controlling subassemblies 5. The subassemblies 5 may involve indicator units for rain warning on the instrument panel of the motor vehicle, an automatic windshield wiping control, a control system for an automatic transmission, a control for the electrical window raisers or an electrical sliding roof operating system or an electrical convertible top. Data on rain intensity is passed on via the data bus 4 and independently evaluated by the connected device-controlling subassemblies 5.

The rain sensor 1 is supplied with electric current through a wire 6. The wire 6 is connected via a switch 7 to a power line 8 of the onboard wiring system which is continuously connected to the operating voltage of the vehicle battery. By closing the switch 7, the rain sensor 1 is supplied with current independently of the operating state of the vehicle, e.g., in the state when the engine is not running. When the switch 7 is opened, the rain sensor 1 is disconnected from the current supply line 8 of the onboard wiring system after which the rain sensor 1 is no longer operating and no power is consumed.

A control circuit 9 controls the opening and closing of the switch 7. The control circuit 9 in this case is triggered by the data bus, comparable to a wakeup function, and therefore also by one of the device-controlling subassemblies 5, or operates autonomously with an internal time circuit. The time control may be independent of the operating state of the vehicle, e.g., the switch 7 may be permanently closed when the engine is running or may have shorter time intervals when the engine is running, during which the switch 7 is open and the rain sensor therefore switched off. Advantageously, the time intervals during which the rain sensor 1 is supplied with current, therefore its switched-on time, is short compared to the times in which the rain sensor 1 is disconnected from the current supply.

Both the switch 7 and the control circuit 9 are preferably semiconductor elements and may form the control device as an integrated circuit.

1. A method for operating a rain sensor of a motor vehicle connected to the onboard wiring system comprising supplying a rain sensor with current in cyclic intervals.

2. The method of claim 1, wherein the cyclic current supply of the rain sensor is periodically time-modulated by a control circuit coordinated with a control device.

3. The method of claim 1, wherein the current supply of the rain sensor is controlled by at least one device-controlling subassembly via a data bus connected to a control device.

4. The method of claim 1, wherein the time interval in which the rain sensor is supplied with current is less than the time interval in which the rain sensor is not supplied with current.

5. A device for operating a rain sensor of a motor vehicle comprising:
an onboard wiring system coupled to the rain sensor;
a control device coupled to said onboard wiring system; and
a switch controlled by said control device that switches a current supply to the rain sensor on and off.

6. The device of claim 1, wherein said control device periodically switches the current supply on and off by means of a control circuit.

7. The device of claim 5, wherein said switch and said control circuit are designed as semiconductor elements and form said control device as an integrated circuit.

8. The device of claim 5, wherein said control device is connected to at least one device-controlling subassembly for operating an electric motor via the data bus.
